(19) United States
(12) Patent Application Publication
(10) Pub. No.: US 2018/0045998 A1
(43) Pub. Date: Feb. 15, 2018

(54) ARRAY SUBSTRATE AND LIQUID CRYSTAL DISPLAY PANEL

(71) Applicant: SHENZHEN CHINA STAR OPTOELECTRONICS TECHNOLOGY CO., LTD, GUANGDONG (CN)

(72) Inventor: YANXI YE, GUANGDONG (CN)

(21) Appl. No.: 14/771,693

(22) PCT Filed: Jun. 5, 2015
(86) PCT No.: PCT/CN2015/080874

§ 371 Date: Aug. 31, 2015

(30) Foreign Application Priority Data
May 6, 2015 (CN) 201510227097.4

(51) Int. Cl. G02F 1/1343; G02F 1/1335

(52) U.S. Cl. CPC G02F 1/1343; G02F 1/133514

(57) ABSTRACT

An array substrate is provided. The array substrate comprises a substrate, a plurality of data lines, a plurality of scan lines, and a plurality of pixel units, wherein each of the pixel units comprises a pixel electrode, which comprises at least one pixel-electrode-main-trunk and a plurality of pixel-electrode-branches extending from the pixel-electrode-main-trunk, wherein a trace-width of the pixel-electrode-branch in a middle area is greater than a trace-width of the pixel-electrode-branch in an edge area.

### FIELD OF THE INVENTION

The present invention relates to a technological field of liquid crystal displays, and more particularly to an array substrate and a liquid crystal display panel.

### BACKGROUND OF THE INVENTION

With the technological development of the society, liquid crystal display devices are used by more and more users. For improving the displaying effect of the liquid crystal display devices, liquid crystal display panels of liquid crystal display devices are designed as multi-domain displays, so as to expand the viewing angle of the liquid crystal display panels.

Refer to FIG. 1, which is a structural schematic view of a conventional liquid crystal display panel. A liquid crystal display panel 10 comprises a color filter substrate 11, an array substrate 12, and a liquid crystal layer 13 located between the color filter substrate 11 and the array substrate 12, wherein an inner surface of the array substrate 12 is provided with a plurality of pixel electrodes 14. Refer to FIG. 2, which is a cross section view of a cross section line A-A′ of FIG. 1. As shown in FIG. 2, each of the pixel electrodes 14 comprises a pixel-electrode-main-trunk 141 and a plurality of pixel-electrode-branches 142 extending in four different directions, and thereby a four-domain display of the liquid crystal display panel 10 is accomplished.

The trace-width and the trace-gap of the pixel-electrode-branches 142 of the conventional pixel electrodes 14 are both constants. For example, the trace-width of each of the pixel-electrode-branches 142 is 3.5 micrometers, and the trace-gap between the two adjacent pixel-electrode-branches 142 is 3 micrometers.

The conventional design for the pixel-electrode-branches 142 is a design of an equal trace-width and equal trace-gap, so that it can simplify the design of the pixel-electrode-branches 142, and the manufacture and detection of the pixel-electrode-branches 142 is more convenient. However, the above-mentioned design for the pixel-electrode-branches 142 does not consider an uneven property of the electric field in the intersection of the pixel-electrode-branches 142. Thus, the uneven electric field easily lowers the whole display effect of the liquid crystal display panel, and the display quality of the liquid crystal display panel 10 is influenced.

Hence, it is necessary to provide an array substrate and a liquid crystal display panel which solves the problem existing in the conventional technology.

### SUMMARY OF THE INVENTION

The object of the present invention is to provide an array substrate and a liquid crystal display panel, which can increase the display effect and the display quality of the liquid crystal display panel, so as to solve a technical problems that the display effect and display quality is lower in the conventional array substrate and the liquid crystal display panel.

For solving the above-mentioned technical problems, the present invention provides a technical solution as follows:

A preferred embodiment of the present invention provides an array substrate, which comprises:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; a trace-width of the pixel-electrode-branch in a middle area is greater than a trace-width of the pixel-electrode-branch in an edge area.

In the array substrate of the present invention, a trace-gap of the pixel-electrode-branch in the middle area is smaller than a trace-gap of the pixel-electrode-branch in the edge area.

In the array substrate of the present invention, the trace-widths are designed according to the distances between the pixel-electrode-branches and the edges of the pixel units.

In the array substrate of the present invention, the trace-gaps are designed according to the distances between the pixel-electrode-branches and the edges of the pixel units.

In the array substrate of the present invention, the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

In the array substrate of the present invention, the array substrate is a COA (color filter on array) substrate, which has a color filter thereon.

A preferred embodiment of the present invention further provides an array substrate, which comprises:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; a trace-gap of the pixel-electrode-branch in a middle area is smaller than a trace-gap of the pixel-electrode-branch in an edge area.

In the array substrate of the present invention, the trace-gaps are designed according to the distances between the pixel-electrode-branches and the edges of the pixel units.

In the array substrate of the present invention, the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

In the array substrate of the present invention, the array substrate is a COA substrate, which has a color filter thereon.

A preferred embodiment of the present invention provides a liquid crystal display panel, which comprises an array substrate, a color filter substrate, and a liquid crystal layer located between the array substrate and the color filter substrate, wherein the array substrate comprises:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; and a trace-width of the pixel-electrode-branch in a middle area is greater than a trace-width of the pixel-electrode-branch in an edge area.

In the liquid crystal display panel of the present invention, a trace-gap of the pixel-electrode-branch in the middle area is smaller than a trace-gap of the pixel-electrode-branch in the edge area.

In the liquid crystal display panel of the present invention, the trace-widths are designed according to the distances between the pixel-electrode-branches and the edges of the pixel units.

In the liquid crystal display panel of the present invention, the trace-gaps are designed according to the distances between the pixel-electrode-branches and the edges of the pixel units.

In the liquid crystal display panel of the present invention, the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

In the liquid crystal display panel of the present invention, the array substrate is a COA substrate, which has a color filter thereon.

Compared with a conventional array substrate and liquid crystal display panel, in the array substrate and the liquid crystal display panel of the preferred embodiment, by disposing the pixel-electrode-branches having different trace-widths and trace-gaps, it can increase the display effect of the liquid crystal display panel, and meanwhile improve the display quality of the liquid crystal display panel, and the thereby the technical problems that the display effect and display quality is lower in the conventional array substrate and the liquid crystal display panel is solved.

The above-mention contents of the present invention can be best understood by referring to the following detailed description of the preferred embodiments and the accompanying drawings.

### DESCRIPTION OF THE DRAWINGS

FIG. 1 is a structural schematic view of a conventional liquid crystal display panel;

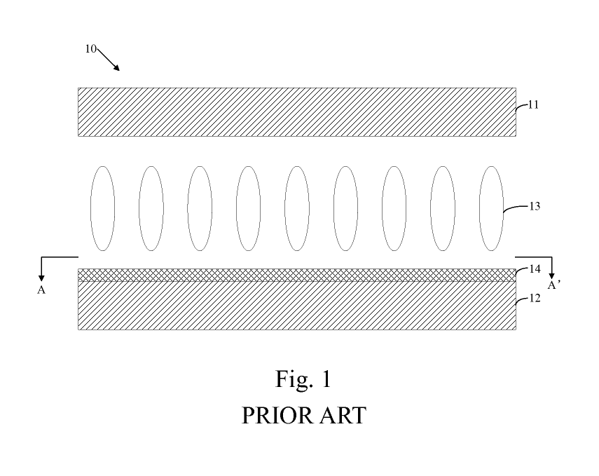

FIG. 2 is a cross section view of a cross section line A-A′ of FIG. 1;

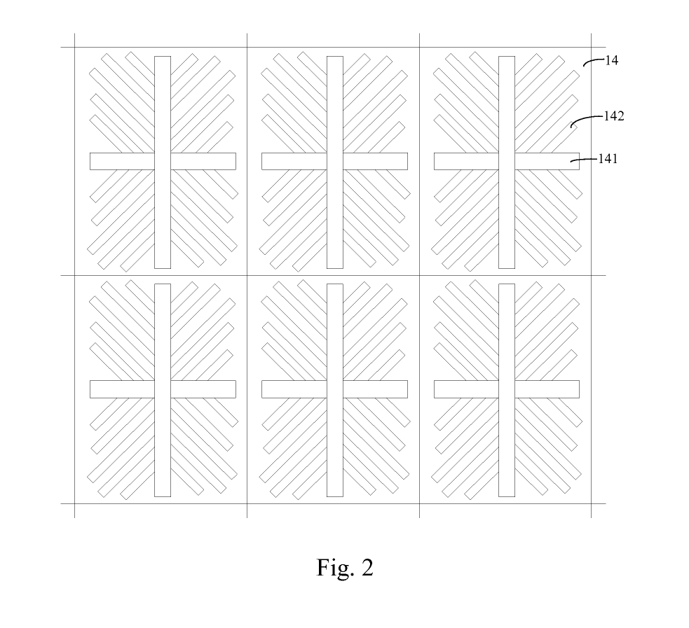

FIG. 3 is a structural schematic view of a pixel unit of an array substrate according to a first preferred embodiment of the present invention;

FIG. 4 is a structural schematic view of a pixel unit of an array substrate according to a second preferred embodiment of the present invention; and

FIG. 5 is a structural schematic view of a pixel unit of an array substrate according to a third preferred embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto. In the drawings, units with similar structures use the same numerals.

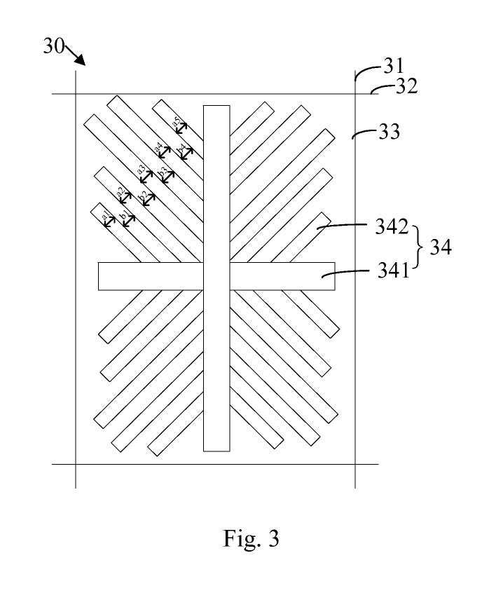

Refer to FIG. 3, which is a structural schematic view of a pixel unit of an array substrate according to a first preferred embodiment of the present invention. An array substrate 30 of the preferred embodiment comprise a substrate (not shown), data lines 31, scan lines 32, and pixel units 33. The data lines 31 are disposed on the substrate, and configured to transmit a data signal; the scan lines 32 are also disposed on the substrate, and configured to transmit a scan signal; and the pixel units 33 are formed by crisscrossing the data lines 31 and the scan lines 32, and each of the pixel units 33 comprises a pixel electrode 34 disposed on an inner surface of the array substrate 30.

Refer to FIG. 3, each of the pixel electrodes 34 comprises at least one pixel-electrode-main-trunk 341 and a plurality of pixel-electrode-branches 342 extending from the pixel-electrode-main-trunk 341. One of the pixel electrodes 34 can comprise four of the pixel-electrode-branches 342 extending in four different directions, and thereby a multi-domain display of a liquid crystal display panel is accomplished.

In the preferred embodiment, on the same display domain of the pixel unit 33, a trace-width of the pixel-electrode-branch 342 in a middle area is greater than a trace-width of the pixel-electrode-branch 342 in an edge area. That is, the trace-widths are designed according to the distances between the pixel-electrode-branches 342 and the edges of the pixel units 33. Additionally, on the same display domain of the pixel units 33, the trace-gaps between the adjacent pixel-electrode-branches 342 are the same. Here the trace-width is the breadth of the pixel-electrode-branch 342, and the trace-gap is the distance between two the adjacent pixel-electrode-branches 342. As shown in FIG. 3, a trace-width a3 is greater than a trace-width a2; the trace-width a2 is greater than a trace-width a1; the trace-width a3 is greater than a trace-width a4; and the trace-width a4 is greater than a trace-width a5. For example, the trace-width a1, trace-width a2, trace-width a3, trace-width a4, and trace-width a5 are respectively 3.1 micrometers, 3.3 micrometers, 3.5 micrometers, 3.3 micrometers, and 3.1 micrometers. In FIG. 3, a trace-gap b1, a trace-gap b2, a trace-gap b3, and a trace-gap b4 are equal. For example, the trace-gap b1, the trace-gap b2, the trace-gap b3, and the trace-gap b4 are all 3 micrometers.

When a liquid crystal display panel corresponding to the array substrate 30 of the preferred embodiment is used, by a gradual change of the trace-widths, from the trace-width of the pixel-electrode-branch 342 in the middle area to the trace-width of the pixel-electrode-branch 342 in the edge area, it can compensate an uneven property of the electric field in the intersection of the pixel-electrode-branches 342. That is, the electric field generated by the display domain of the pixel-electrode-branches 342 can be more even, so as to improve the display quality of the liquid crystal display panel.

Preferably, the array substrate 30 can be an array substrate which only has the pixel electrodes thereon, but can also be a COA (color filter on array) substrate, which further has a color filter thereon.

In the array substrate of the preferred embodiment, by disposing the pixel-electrode-branches having different trace-widths, it can increase the display effect of the liquid crystal display panel, and meanwhile improve the display quality of the liquid crystal display panel.

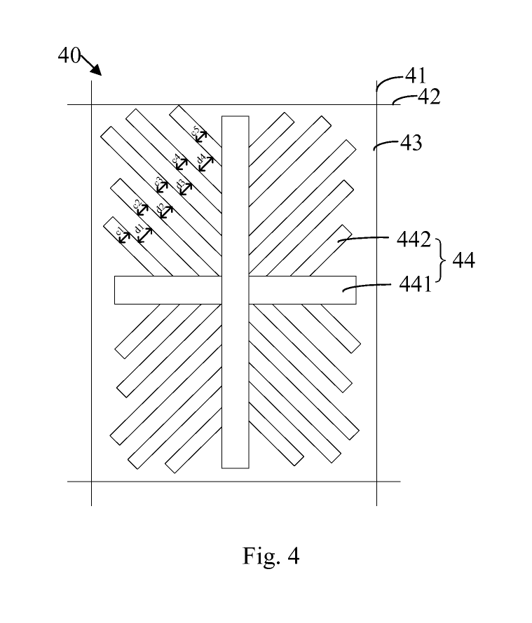

Refer to FIG. 4, which is a structural schematic view of a pixel unit of an array substrate according to a second preferred embodiment of the present invention. An array substrate 40 of the preferred embodiment comprises a substrate (not shown), data lines 41, scan lines 42, and pixel units 43. The data lines 41 are disposed on the substrate, and configured to transmit a data signal; the scan lines 42 are also disposed on the substrate, and configured to transmit a scan signal; and the pixel units 43 are formed by crisscrossing the data lines 41 and the scan lines 42, and each of the pixel units 43 comprises a pixel electrode 44 disposed on an inner surface of the array substrate 40.

Refer to FIG. 4, each of the pixel electrodes 44 comprises at least one pixel-electrode-main-trunk 441 and a plurality of pixel-electrode-branches 442 extending from the pixel-electrode-main-trunk 441. One of the pixel electrode 44 can comprise four of the pixel-electrode-branches 442 extending in four different directions, and thereby a multi-domain display of a liquid crystal display panel is accomplished.

In the preferred embodiment, on the same display domain of the pixel unit 43, a trace-gap of the pixel-electrode-branch 442 in a middle area is smaller than a trace-gap of the pixel-electrode-branch 442 in an edge area. That is, the trace-gaps are designed according to the distances between the pixel-electrode-branches 442 and the edges of the pixel units 43. Additionally, on the same display domain of the pixel units 43, the trace-widths between the adjacent pixel-electrode-branches 342 are the same. Here the trace-width is the breadth of the pixel-electrode-branch 442, and the trace-gap is the distance between two the adjacent pixel-electrode-branches 442. As shown in FIG. 4, a trace-width c1, a trace-width c2, a trace-width c3, and a trace-width c4 are equal. For example, the trace-width c1, the trace-width c2, the trace-width c3, and the trace-width c4 are all 3.5 micrometers. In FIG. 4, a trace-gap d1 is greater than a trace-gap d2; and a trace-gap d4 is greater than a trace-gap d3. For example, the trace-gap d1, trace-gap d2, trace-gap d3, and trace-gap d4 are respectively 3 micrometers, 2.7 micrometers, 2.7 micrometers, and 3 micrometers.

When a liquid crystal display panel corresponding to the array substrate 40 of the preferred embodiment is used, by a gradual change of the trace-gaps, from the trace-gap of the pixel-electrode-branch 442 in the middle area to the trace-gap of the pixel-electrode-branch 442 in the edge area, it can compensate an uneven property of the electric field in the intersection of the pixel-electrode-branches 442. That is, the electric field generated by the display domain of the pixel-electrode-branches 442 can be more even, so as to improve the display quality of the liquid crystal display panel.

Preferably, the array substrate 40 can be an array substrate which only has the pixel electrodes thereon, but also can be a COA (color filter on array) substrate, which further has a color filter thereon.

In the array substrate of the preferred embodiment, by disposing the pixel-electrode-branches having different trace-gaps, it can increase the display effect of the liquid crystal display panel, and meanwhile improve the display quality of the liquid crystal display panel.

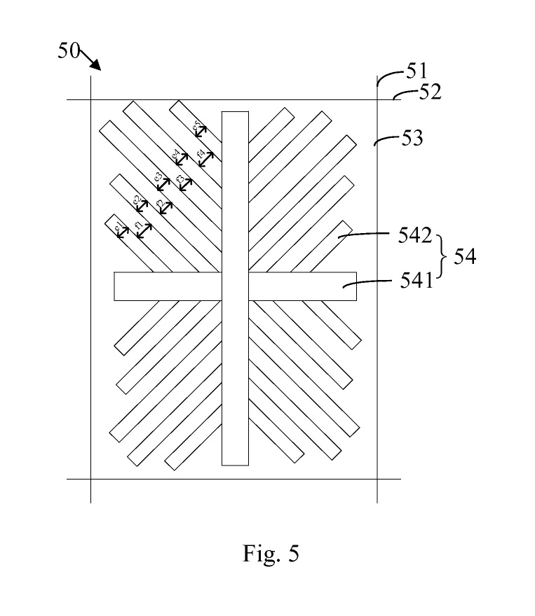

Refer to FIG. 5, which is a structural schematic view of a pixel unit of an array substrate according to a third preferred embodiment of the present invention. An array substrate 50 of the preferred embodiment comprise a substrate (not shown), data lines 51, scan lines 52, and pixel units 53. The data lines 51 are disposed on the substrate, and configured to transmit a data signal; the scan lines 52 are also disposed on the substrate, and configured to transmit a scan signal; and the pixel units 53 are formed by crisscrossing the data lines 51 and the scan lines 52, and each of the pixel units 53 comprises a pixel electrode 54 disposed on an inner surface of the array substrate 50.

Refer to FIG. 5, each of the pixel electrodes 54 comprises at least one pixel-electrode-main-trunk 541 and a plurality of pixel-electrode-branches 542 extending from the pixel-electrode-main-trunk 541. One of the pixel electrodes 54 can comprises four of the pixel-electrode-branches 542 extending in four different directions, and thereby a multi-domain display of a liquid crystal display panel is accomplished.

In the preferred embodiment, on the same display domain of the pixel unit 53, a trace-width of the pixel-electrode-branch 542 in a middle area is greater than a trace-width of the pixel-electrode-branch 542 in an edge area; and a trace-gap of the pixel-electrode-branch 542 in the middle area is smaller than a trace-gap of the pixel-electrode-branch 542 in the edge area. Here the trace-width is the breadth of the pixel-electrode-branch 542, and the trace-gap is the distance between two the adjacent pixel-electrode-branches 542. As shown in FIG. 5, a trace-width e3 is greater than a trace-width e2; the trace-width e2 is greater than a trace-width e1; the trace-width e3 is greater than a trace-width e4; and the trace-width e4 is greater than a trace-width e5. For example, the trace-width e1, trace-width e2, trace-width e3, trace-width e4, and trace-width e5 are respectively 3.1 micrometers, 3.3 micrometers, 3.5 micrometers, 3.3 micrometers, and 3.1 micrometers. In FIG. 3, a trace-gap f1 is greater than a trace-gap f2; and a trace-gap f4 is greater than a trace-gap f3. For example, the trace-gap f1, trace-gap f2, trace-gap f3, and trace-gap f4 are respectively 3 micrometers, 2.7 micrometers, 2.7 micrometers, and 3 micrometers.

When a liquid crystal display panel corresponding to the array substrate 50 of the preferred embodiment is used, by a gradual change of the trace-widths, from the trace-width of the pixel-electrode-branch 542 in the middle area to the trace-width of the pixel-electrode-branch 542 in the edge area, and a gradual change of the trace-gaps, from the trace-gap of the pixel-electrode-branch 542 in the middle area to the trace-gap of the pixel-electrode-branch 542 in the edge area, it can compensate an uneven property of the electric field in the intersection of the pixel-electrode-branches 542. That is, the electric field generated by the display domain of the pixel-electrode-branches 542 can be more even, so as to improve the display quality of the liquid crystal display panel.

Preferably, the sum of the trace-width of the pixel-electrode-branch 542 and the trace-gap of the pixel-electrode-branch 542 in the middle area is equal to the sum of the trace-width of the pixel-electrode-branch 542 and the trace-gap of the pixel-electrode-branch 542 in the edge area. In the preferred embodiment, the sum of trace-width e1 and trace-gap f1 is 6.1 micrometers; the sum of trace-width e2 and trace-gap f2 is 6.1 micrometers; the sum of trace-width e4 and trace-gap f3 is 6.1 micrometers; and the sum of trace-width e5 and trace-gap f4 is 6.1 micrometers. When the sum of the trace-width of the pixel-electrode-branch 542 and the trace-gap of the pixel-electrode-branch 542 in the middle area is equal to the sum of the trace-width of the pixel-electrode-branch 542 and the trace-gap of the pixel-electrode-branch 542 in the edge area, it can obtain the best even property of the electric field in the intersection of the pixel-electrode-branches 342, and improve the display effect and display quality of the liquid crystal display panel.

The present invention further provides a liquid crystal display panel, which comprises an array substrate, a color filter substrate, and a liquid crystal layer located between the array substrate and the color filter substrate. The array substrate comprises a substrate, a plurality of data lines, a plurality of scan lines, and a plurality of pixel units, wherein the data lines are disposed on the substrate and configured to transmit a data signal; the scan lines are disposed on the substrate and configured to transmit a scan signal; and the pixel units are formed by crisscrossing the data lines and the scan lines, and each of the pixel units comprises a pixel electrode disposed on an inner surface the array substrate.

In the preferred embodiment, each of the pixel electrodes comprises at least one pixel-electrode-main-trunk and a plurality of pixel-electrode-branches extending from the pixel-electrode-main-trunk. One of the pixel electrodes can comprise four of the pixel-electrode-branches extending in four different directions, and thereby a multi-domain display of a liquid crystal display panel is accomplished.

Preferably, a trace-width of the pixel-electrode-branch in the middle area is greater than a trace-width of the pixel-electrode-branch in the edge area.

Preferably, a trace-gap of the pixel-electrode-branch in the middle area is smaller than a trace-gap of the pixel-electrode-branch in the edge area.

Preferably, the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

The specific operation principle of the liquid crystal display device of the present invention is the same or similar to the description of the above-mentioned embodiments, so please refer to the related description of the above-mentioned embodiments.

In the array substrate and the liquid crystal display panel of the preferred embodiment, by disposing the pixel-electrode-branches having different trace-widths and trace-gaps, it can increase the display effect of the liquid crystal display panel, and meanwhile improve the display quality of the liquid crystal display panel, and the thereby the technical problems that the display effect and display quality is lower in the conventional array substrate and the liquid crystal display panel is solved.

The present invention has been described with preferred embodiments thereof and it is understood that many changes and modifications to the described embodiments can be carried out without departing from the scope and the spirit of the invention that is intended to be limited only by the appended claims.

1. An array substrate, comprising:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; a trace-width of the pixel-electrode-branch in a middle area is greater than a trace-width of the pixel-electrode-branch in an edge area.

2. The array substrate according to claim 1, wherein a trace-gap of the pixel-electrode-branch in the middle area is smaller than a trace-gap of the pixel-electrode-branch in the edge area.

3. The array substrate according to claim 1, wherein the trace-widths are designed according to the distances between the pixel-electrode-branches and the edges of the pixel units.

4. The array substrate according to claim 2, wherein the trace-gaps are designed according to the distances between the pixel-electrode-branches and the edges of the pixel units.

5. The array substrate according to claim 1, wherein the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

6. The array substrate according to claim 1, wherein the array substrate is a COA (color filter on array) substrate, which has a color filter thereon.

7. An array substrate, comprising:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; a trace-gap of the pixel-electrode-branch in a middle area is smaller than a trace-gap of the pixel-electrode-branch in an edge area.

8. The array substrate according to claim 7, wherein the trace-gaps are designed according to the distances between the pixel-electrode-branches and the edges of the pixel units.

9. The array substrate according to claim 7, wherein the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

10. The array substrate according to claim 7, wherein the array substrate is a COA substrate, which has a color filter thereon.

11. A liquid crystal display panel, comprising an array substrate, a color filter substrate, and a liquid crystal layer located between the array substrate and the color filter substrate, wherein the array substrate comprises:
a substrate;
a plurality of data lines disposed on the substrate and being configured to transmit a data signal;
a plurality of scan lines disposed on the substrate and being configured to transmit a scan signal; and
a plurality of pixel units formed by crisscrossing the data lines and the scan lines, wherein each of the pixel units comprises a pixel electrode disposed on an inner surface the array substrate;
wherein each of the pixel electrodes comprises at least one pixel-electrode-main-trunk and a plurality of pixel-electrode-branches extending from the pixel-electrode-main-trunk; and a trace-width of the pixel-electrode-branch in a middle area is greater than a trace-width of the pixel-electrode-branch in an edge area.

12. The liquid crystal display panel according to claim 11, wherein a trace-gap of the pixel-electrode-branch in the middle area is smaller than a trace-gap of the pixel-electrode-branch in the edge area.

13. The liquid crystal display panel according to claim 11, wherein the trace-widths are designed according to the distances between the pixel-electrode-branches and the edges of the pixel units.

14. The liquid crystal display panel according to claim 12, wherein the trace-gaps are designed according to the distances between the pixel-electrode-branches and the edges of the pixel units.

15. The liquid crystal display panel according to claim 11, wherein the sum of the trace-width of the pixel-electrode-branch and the trace-gap of the pixel-electrode-branch in the middle area is equal to the sum of the trace-width of the pixel-electrode-branch and the trace-gap of the pixel-electrode-branch in the edge area.

16. The liquid crystal display panel according to claim 11, wherein the array substrate is a COA substrate, which has a color filter thereon.
